(19) United States
(12) Patent Application Publication
(10) Pub. No.: US 2009/0012198 A1
(43) Pub. Date: Jan. 8, 2009

(54) Ultraviolet Ray Curing Type Resin Composition

(75) Inventors: Makoto Araumi, Chiba (JP); Norio Suzuki, Saitama (JP); Naoto Ishii, Saitama (JP)

Correspondence Address: ARENT FOX LLP, 1050 CONNECTICUT AVENUE, N.W., SUITE 400, WASHINGTON, DC, 20036, US

(73) Assignee: HONDA MOTOR CO LTD., MINATO-KU TOKYO (JP)

(21) Appl. No.: 11/795,644

(22) PCT Filed: Nov. 5, 2003
(86) PCT No.: PCT/JP03/14121

§ 371 Date: Apr. 8, 2008

(30) Foreign Application Priority Data
Nov. 6, 2002 (JP) 2002-322424

(51) Int. Cl. C08J 3/28

(52) U.S. Cl. 522/35; 522/96

(57) ABSTRACT

An ultraviolet ray curing type resin composition comprising (A) an urethane acrylate produced from, as essential ingredients, an isocyanate compound comprising an aliphatic isocyanate compound and an alicyclic isocyanate compound at a molar ratio of from 80/20 to 20/80; a polyol compound comprising an ester-based polyol, an ether-based polyol or a polycarbonate-based polyol; and an acrylate compound having a hydroxyl group, (B) an acrylate-based reactive diluent, and (C) a photo-reactive initiator. The coated film obtained by coating the composition to a substrate, followed by photocuring has a following capability in molding owing to its excellent elongation, and only-causes a low level of yellowing upon long time heating to show an excellent thermal resistance. The cured product has a decreased residual odor and, therefore, useful in improving designing property and beauty in using for an automobile interior or the like. Further, the composition is suitable for forming a matted surface by printing to a substrate.

### TECHNICAL FIELD

The present invention relates to an ultraviolet ray curing type resin composition. Particularly, it relates to an ultraviolet ray curing type resin composition having the following properties: The coated film obtained by coating the composition to a substrate, followed by photocuring has a following capability in molding owing to its excellent elongation; Upon long time heating, the film only causes a low level of yellowing to show an excellent thermal resistance; The cured product has a decreased residual odor so that it is useful in improving designing property and beauty in using for an automobile interior or the like; Particularly, it is suitable for forming a matted surface by printing to a substrate.

### BACKGROUND ART

Conventionally, in the use field as described above, ultraviolet ray curing type resin compositions such as urethane acrylate and epoxy acrylate have been used. Improvements in friction resistance and scratch resistance of these resins have been tried to be achieved.

However, with spreading the use of the ultraviolet ray curing type resin composition, in a case where a film coated to a sheet is cured by ultraviolet ray and the resulting sheet is subjected to molding processing to be adopted to various uses such as interior materials, the coated film of the sheet for molding has been strongly required to have flexibility and surface hardness, and further, in this new processing technique, the coated film has been required to have excellent elongation upon molding.

However, in conventional examples, because of insufficient elongation in a coated film upon molding, in a portion to be coated particularly requiring a high elongation of the film, cracks or breakages of the film may occur to cause a problem of forming a desirable coated film with difficulty.

While, ultraviolet ray curing type resins comprising oligomers such as urethane acrylate and epoxy acrylate, wherein elongation property is improved, have been placed on the market. However, these resins have problems of, e.g., having surface tacking caused by insufficient curing due to their poor curing ability, causing yellowing upon long time heating to lose thermal resistance.

Further, in conventional examples, cured products have a high residual odor so that in their use in, e.g., an automobile, several problems may be caused.

Accordingly, an object of the present invention is to provide a technique capable of eliminating the forgoing defects in the prior art technique.

The foregoing object and other objects, as well as novel characteristics of the present invention also will be apparent from the following description of this specification.

### DISCLOSURE OF THE INVENTION

According to the present invention, there is provided an ultraviolet ray curing type resin composition including:

(A) an urethane acrylate produced from, as essential ingredients, (a) an isocyanate compound comprising an aliphatic isocyanate compound and an alicyclic isocyanate compound at a molar ratio of from 80/20 to 20/80, (b) a polyol compound comprising an ester-based polyol, an ether-based polyol or a polycarbonate-based polyol and (c) an acrylate compound having a hydroxyl group,

(B) an acrylate-based reactive diluent, and

(C) a photo-reactive initiator.

Preferably, the molar ratio of the aliphatic isocyanate compound and the alicyclic isocyanate compound is from 80/20 to 50/50.

Preferably, the acrylate-based reactive diluent is an acrylate-based reactive diluent having an imide group.

Preferably, the photo-reactive initiator is a polymer of hydroxyketone.

Preferably, the polyol compound is an ester-based polyol including sebacic acid and 3-methyl-1,5-pentanediol.

Preferably, the ester-based polyol includes an ester-based polyol including sebacic acid and 3-methyl-1,5-pentanediol and an ester-based polyol including adipic acid and neopentyl glycol, and the ratio of the former to the latter is from 20/80 to 80/20.

Preferably, the acrylate compound having a hydroxyl group is a monofunctional epoxyacrylate compound represented by the following general formula (1);

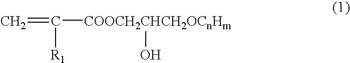

wherein R₁ represents H or CH₃; n is an integer of from 8 to 15; and m is an integer of from 17 to 31.

Preferably, a molded product including the ultraviolet ray curing type resin composition has an elongation rate of 10% or more.

Further, according to the present invention, there is provided a method for forming a matted surface including: a step of generating fine shrinks on the cured resin surface of the aforementioned ultraviolet ray curing type resin composition by irradiating ultraviolet ray to the ultraviolet ray curing type resin composition using an ultraviolet lamp having maximum emission intensity at a wavelength of 300 nm or less and a 20% or less of relative emission intensity at a wavelength of from 300 nm to 800 nm; and a step of curing of the composition to form the matted surface.

Further, there is provided a method for forming a matted surface including: a step of generating fine shrinks on the cured resin surface of the aforementioned ultraviolet ray curing type resin composition by irradiating ultraviolet ray to the ultraviolet ray curing type resin composition using an ultraviolet lamp having maximum emission intensity at a wavelength of 300 nm or less and a 20% or less of relative emission intensity at a wavelength of from 300 nm to 800 nm to cause curing of the composition; and a step of successively irradiating ultraviolet ray thereto using an ultraviolet lamp having maximum emission intensity at a wavelength of 300 nm or more to cause curing of the composition.

### BEST MODE FOR CARRYING OUT THE INVENTION

The present invention will be described in detail below.

As the aliphatic isocyanate compound of (a) an isocyanate compound to be used in the present invention, for example, mention may be made of hexamethylene diisocyanate and trimethyl hexamethylene diisocyanate.

While, as the alicyclic isocyanate compound, for example, mention may be made of isophorone diisocyanate and 4,4′-dicyclohexylmethane isocyanate.

A hydrogenated MDI, for example, represented by the following chemical formula (2);

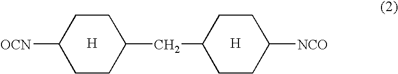

and a hydrogenated xylenediisocyanate can be used.

In (a) an isocyanate compound of the present invention, an aliphatic isocyanate compound and an alicyclic isocyanate compound are used at a molar ratio of from 80/20 to 20/80. When the proportion of the aliphatic isocyanate compound is less than 20, the coated film to be obtained is too tough to deteriorate elongation. Thus, the object of the present invention is achieved with difficulty. While, when the proportion of the aliphatic isocyanate compound exceeds 80, the coated film is insufficient in strength to have poor elongation. Thus, the object of the present invention is achieved with difficulty. Particularly, in the present invention, it is preferable that an aliphatic isocyanate compound and an alicyclic isocyanate compound are used at a molar ratio of from 80/20 to 50/50. Namely, the molar ratio of the aliphatic isocyanate compound to the alicyclic isocyanate compound of from more than 50 to less than 80 is preferable for achieving the foregoing object.

As (b) a polyol compound to be used in the present invention, mention may be made of an ester-based polyol, an ether-based polyol and a polycarbonate-based polyol. In particular, the ester-based polyol is preferable in view of achieving the object of the present invention such as elongation of a coated film.

As the foregoing ester-based polyol, for example, mention may be made of an ester compound obtained by reacting diols with dicarboxylic acids.

Examples of the diol include 3-methyl-1,5-pentanediol, neopentyl glycol, ethylene glycol, diethylene glycol, propylene glycol, dipropylene glycol, 1,3-butanediol, 1,4-butanediol, 1,6-hexanediol, 2-methyl-1,8-octanediol, 1,9-nonanediol and the like.

Examples of the dicarboxylic acid include sebacic acid, adipic acid, a dimmer acid, succinic acid, azelaic acid, maleic acid, terephthalic acid, isophthalic acid, citoraconic acid, and the anhydrides thereof.

Of the ester-based polyol, those using sebacic acid are preferable in view of desirable moldability, thermal resistance, adhesion with various substrates, resin viscosity, and physical properties of a coated film. In particular, the ester-based polymer comprising sebacic acid and 3-methyl-1,5-pentanediol is preferable.

As the ester-based polyol, those having an (average) molecular weight of 1,000 to 4,000 or those having a bifunctional hydroxyl group are preferable in view of the same reasons as described above.

Different kinds of ester-based polyols can be used together. For example, the ester-based polyol comprising sebacic acid and 3-methyl-1,5-pentanediol and the ester-based polyol comprising adipic acid and neopentyl glycol can be used as a mixture. In such a case, when a ratio of the former polyol to the latter polyol is from 20/80 to 80/20, preferably from 40/60 to 60/40, those having the foregoing excellent physical properties such as moldability, thermal resistance and the like can be preferably obtained.

As the ether-based polymer, mention may be made of polyetherdiol, poly(oxytetramethylene)glycol, poly(oxybutylene)glycol, and the like. Specific examples of the polyetherdiol include polypropylene glycol, polyethylene glycol, polytetramethylene glycol and propylene-modified polytetramethylene glycol.

As the polycarbonate-based polyol, for example, mention may be made of reaction products of carbonate derivatives and diols. Examples of the carbonate derivatives include diallyl carbonates such as diphenyl carbonate, dimethyl carbonate and diethyl carbonate. As the diols, those as exemplified above can be mentioned.

As (c) an acrylate compound having a hydroxyl group to be used in the present invention, for example, a monofunctional epoxyacrylate compound represented by the following formula (1) preferably can be mentioned in view of desirable moldability, thermal resistance, adhesion with various substrates, resin viscosity and physical properties of a coated film. It should be noted that an acrylate compound having a hydroxyl group to be used in the present invention includes a methacrylate compound.

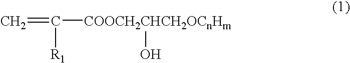

In the formula, R₁ represents H or CH₃, n is an integer of from 8 to 15, and m is an integer of from 17 to 31.

Specific examples thereof include 2-hydroxyethyl(meth)acrylate, 2-hydroxypropyl(meth)acrylate, 2-hydroxybutyl(meth)acrylate, 4-hydroxybutylmethacrylate, polyethyleneglycolmono(meth)acrylate, and polypropyleneglycolmono(meth)acrylate,

Particularly, of the (meth)acrylate compound having a hydroxyl group, those represented by the forgoing general formula wherein R₁ represents H are preferable. Commercially available Ebecryl 112 (produced by Daicel UCB Co., Ltd.) and the like can be used.

(A) an urethane acrylate according to the present invention, wherein a molar ratio of an aliphatic isocyanate compound and an alicyclic isocyanate compound is from 80/20 to 20/80, preferably from 80/20 to 50/50, can be obtained by reacting, as essential ingredients, the aliphatic isocyanate compound and the alicyclic isocyanate compound, a polyol compound such as an ester-based polyol, and a (meth)acrylate compound having a hydroxyl group. The reaction manner is as follows: These essential ingredients are charged at once to effect a reaction; These isocyanate compounds and the polyol compound are reacted to once produce a prepolymer having excessive amount of isocyanate groups, successively remaining isocyanate groups are reacted with the (meth)acrylate compound having a hydroxyl group; and The (meth)acrylate compound having a hydroxyl group and these isocyanate compounds are reacted to once produce a prepolymer having excessive amount of isocyanate groups, successively remaining isocyanate groups are reacted with the polyol compound.

A ratio (equivalent ratio) of an NCO group of the isocyanate compound with an OH group of the polyol, in the reaction of the aliphatic isocyanate compound and the alicyclic isocyanate compound, the polyol compound, and the (meth)acrylate compound having a hydroxyl group, is preferably NCO/OH=1.5 to 2.0, particularly preferably from 1.6 to 1.8 in view of achieving the objects of the present invention such as improvement in elongation and thermal resistance.

A ratio of a prepolymer having a terminal isocyanate group, which is obtained by the reaction of an aliphatic isocyanate compound and an alicyclic isocyanate compound with a polyol compound, to a (meth)acrylate compound having a hydroxyl group is preferably from 1.0 to 1.05 in terms of an equivalent ratio in view of achieving the objects of the present invention such as improvement in elongation and thermal resistance.

In the foregoing reaction, in order to prevent radical polymerization, a polymerization inhibitor such as methoquinone or hydroquinone is preferably added in an amount of from 50 to 1000 ppm based on the amount of the reaction product. The reaction temperature of the foregoing reaction is preferably from 40 to 80° C. Upon necessity, a catalyst such as dibutyltin laurate may be added to the reaction mixture.

In the present invention, the reaction can be effected in a reactive diluent having a function of lowering viscosity. As the reactive diluent, can be used monofunctional reactive diluents such as imideacrylate, isobornyl(meth)acrylate, dicyclopentenyl(meth)acrylate, dicyclopentanyl(meth)acrylate, phenoxyethyl(meth)acrylate, phenoxypolyethylene glycol(meth)acrylate, alkyl(meth)acrylate, cyclohexyl(meth)acrylate, tetrahydroxyfurfuryl(meth)acrylate, benzyl(meth)acrylate, acroylmorpholinedimethyl acrylamide, vinylcaprolactone and vinyl formamide; and bifunctional reactive diluents such as polyethylene glycoldi(meth)acrylate, polypropylene glycoldi(meth)acrylate, 1,4-butanediol(meth)acrylate and 1,6-hexanediol(meth)acrylate. However, use of an acrylate-based reactive diluent having an imide group (imideacrylate) is preferable in view of not only satisfying elongation or thermal yellowing resistance of a coated film, but also forming a matted surface having an excellent designing property and obtaining a product having less odor.

In accordance with the present invention, an ultraviolet ray curing type resin composition can be constructed by including (A) an urethane acrylate, (B) an acrylate-based reactive diluent, and (C) a photo-reactive initiator.

In the foregoing (B) an acrylate-based reactive diluent, the acrylate-based reactive diluent exemplified above can be used as the component as described above. However, according to the extensive study and research efforts by the present inventors, it has become apparent that particularly, the use of an imideacrylate is preferable in view of the reproducibility of a matted surface, elongation rate and curing property of a coated film. Incidentally, in a case where isobornyl(meth)acrylate is used, although elongation rate or thermal yellowing resistance of a coated film is satisfactory (elongation rate: 118%, thermal yellowing resistance 5E=2.3), several problems may arise such as a formation of a matted surface with difficulty and a strong odor (degree of odor=204). However, in a case where imideacrylate is used, not only elongation and thermal yellowing resistance of a coated film are satisfactory (elongation rate: 120%, thermal yellowing resistance δE=2.3) as can be seen from the later-described Examples, but also a matted surface having an excellent designing property is formed and a product having less odor (degree of odor=12, It should be noted that a polymerized product of hydroxyketone is used as a photo-reactive initiator) is obtained.

As the imideacrylate, typically, n-acroyl oxyethylhexahydrophthalimide can be exemplified. As the imideacrylate, for example, commercially available Allonix TO-1429 produced by Toagosei Co., Ltd. or the like can be used.

The use amount of (B) an acrylate-based reactive diluent is from 10 to 150 parts by weight based on 100 parts by weight of (A) a urethane acrylate.

When (B) an acrylate-based reactive diluent is used in an amount of less than 10 parts by weight based on 100 parts by weight of (A) an urethane acrylate, noticeable effects cannot be provided in the aspects of reproducibility of a matted surface, elongation rate, curing property and thermal yellowing resistance of a coated film. Thus, the object of the present invention can be achieved with difficulty. While even when it exceeds 150 parts by weight, noticeably effects cannot be provided in the aspects of reproducibility of a matted surface, elongation rate, curing property and thermal yellowing resistance of a coated film. When the diluent is used in an amount of more than the forgoing amount, the foregoing effects are not increased any more, which is not advantageous in economical aspect.

As (C) a photo-reactive initiator to be used in the present invention, for example, mention may be made of a polymer of hydroxyketone such as an oligo{2-hydroxy-2-methyl-1-phenylpropaneone}, 1-hydroxydicyclohexylphenyl ketone, 2-hydroxy-2-methyl-1-phenylpropane-1-one, 2,2-dimethoxy-1,2-diphenylethane-1-one, 1{4(2-hydroxyethoxy)phenyl}2-hydroxy-2-methyl-1-propane-1-one, 2,4,6-trimethylbenzoyldiphenylphosphineoxide, bis(2,4,6-trimethylbenzoyl)phenylphosphineoxide and the like. According to the extensive study and research efforts of the present inventors, it has become apparent that the use of the polymer of hydroxyketone adapts the object of the present invention such as the noticeable reduction of the residual odor of a cured product.

The photo-polymerization initiator is used in an amount of from 0.1 to 15 parts by weight, preferably from 5 to 10 parts by weight based on 100 parts by weight of (A) a urethane acrylate.

When the photo-polymerization initiator is used in an amount of less than 0.1 part by weight based on 100 parts by weight of (A) an urethane acrylate, the object of the present invention can be achieved with difficulty, e.g., the residual odor cannot be sufficiently eliminated. While even when it exceeds 15 parts by weight, the object of the present invention can be achieved with difficulty, e.g., the residual odor cannot be sufficiently eliminated.

The photo-polymerization initiator also can be used in combination with one or two or more kinds of photo-polymerization accelerator such as N,N-dimethyl isoamylbenzoate and N,N-dimethyl ethylbenzoate.

To the ultraviolet ray curing type resin composition of the present invention, optionally can be added other components such as photosensitizer, leveling agent, antioxidant, dispersant, defoamer, photostabilizer, ultraviolet absorber, inorganic filler, organic filler, ionoganic pigment, organic pigment, extender pigment and the like.

Further, various kinds of solvents such as an ester, an ether, a ketone, an alcohol, an aromatic solvent and an aliphatic solvent can be added for the purpose of, e.g., controlling a viscosity.

The ultraviolet ray curing type resin composition of the present invention is coated on a substrate (coating print), ultraviolet ray is irradiated thereto to cure the coated film, whereby fine shrinks are generated on the cured resin surface to be able to form a matted surface.

The foregoing substrate is not particularly limited. Namely, the material thereof is not particularly limited and it can be plastic, paper, metal, wood or the like. The shape of the substrate is also not particularly limited. Namely, it can be film, sheet or other molded products.

Ultraviolet ray is irradiated to an ultraviolet ray curing type resin composition using, for example, an ultraviolet lamp comprising a low pressure mercury lamp, which has maximum emission intensity at a wavelength of 300 nm or less and a 20% or less of relative emission intensity at a wavelength of from 300 nm to 800 nm, so that the composition may be cured to generate fine shrinks on the cured resin surface, whereby the matted surface can be formed.

After forming shrinks by irradiating ultraviolet ray to cause curing, ultraviolet ray is irradiated to the cured resin again using, for example, an ultraviolet lamp such as a high-pressure mercury lamp or metal halide, to cure the coated film. According to such procedure, curing proceeds inside the film so that curing can be effected sufficiently.

The ultraviolet ray curing type resin composition comprising (A) a urethane acrylate of the present invention is useful for forming a matted surface as described above. The composition is excellent in elongation upon its molding processing. Further, it gives a cured coated film having a preferable thermal resistance and an excellent adhesion with a substrate, which will be shown in the later-described Examples. Thus, in a case where a sheet is subjected to molding processing to form an interior material, the composition is suitable for forming the coated film of the foregoing sheet for molding. Further, the composition can be used, for example, as a protective coating film of a plastic and a coating material of an optical glass fiber. Still further, the composition can be used not only for the formation of a coated film, but also as resins for molding various resins.

The ultraviolet ray curing type resin composition comprising (A) a urethane acrylate of the present invention shows an elongation rate of 10% or more by the ultraviolet ray curing as described above. Generally, the upper limit of the elongation rate is 300%.

The foregoing elongation (rate, %) is determined according to the method of JIS K-7127 (tensile test specification of plastic material) and is shown in terms of the maximum elongation of a tensile test piece.

As can be seen from the later-described Comparative Examples, some commercially available urethane acrylate oligomers show an elongation rate of 10% or more in case of using an acrylate-based reactive diluent. However, in a case where as the isocyanate compound, an alicyclic isocyanate compound is used alone, contrary to the present invention wherein an aliphatic isocyanate compound and an alicyclic isocyanate compound are used together, the elongation rate is at most 10% or less.

### EXAMPLES

The present invention will be described in detail by way of Examples and Comparative Examples. However, the present invention is not limited to Examples described below. In Examples, parts are by weight.

### Synthesis Example 1

### Synthesis of urethane (meth)acrylate

To a 2 l flask equipped with a stirrer, a thermometer, a temperature-controlling unit and a condenser are charged 151.2 g of hexamethylene diisocyanate, 235.8 g of hydrogenated MDI, and 2000 g of a polyester of sebacic acid and 3-methyl-1,5-pentanediol (Kurarepolyol P-2050, molecular weight 2000, produced by Kurare Co. Ltd.). The content of the flask is heated to 80° C. and reacted for 5 hours. Successively, the reaction mixture is cooled to 60° C. Then, 95.7 g of 2-hydroxyethyl acrylate, 1.8 g of methoquinone, and 0.7 g of dibutyltin dilaurate are charged thereto, followed by reacting at 80° C. for 7 hours. The disappearance of the remaining isocyanate group in the reaction mixture is confirmed by infrared absorption spectrum. Thereafter, 620.7 g of imide acrylate (Allonix TO-1429 produced by Toagosei Co., Ltd.) are charged to the reaction mixture, stirred for 2 hours and then taken out from the flask.

### Synthesis Example 2

### Synthesis of urethane (meth)acrylate

To a 2 l flask equipped with a stirrer, a thermometer, a temperature-controlling unit and a condenser are charged 50.4 g of hexamethylene diisocyanate, 15.5 g of isophorone diisocyanate, 250 g of a polyester of sebacic acid and 3-methyl-1,5-pentanediol (Kurarepolyol P-3050, molecular weight 3000, produced by Kurare Co. Ltd.), and 250 g of a polyester of neopentyl glycol and adipic acid (Polylite OD-X-2044, molecular weight 2000, produced by Dainippon Ink). The content of the flask is heated to 80° C. and reacted for 5 hours. Successively, the reaction mixture is cooled to 60° C. Then, 38.7 g of 2-hydroxyethyl acrylate, 0.3 g of methoquinone, and 0.2 g of dibutyltin dilaurate are charged thereto, followed by reacting at 80° C. for 7 hours. The disappearance of the remaining isocyanate group in the reaction mixture is confirmed by infrared absorption spectrum. Thereafter, 151.2 g of imide acrylate (Allonix TO-1429 produced by Toagosei Co., Ltd.) are charged to the reaction mixture, stirred for 2 hours and then taken out from the flask.

### Synthesis Example 3

### Synthesis of urethane (meth)acrylate

To a 2 l flask equipped with a stirrer, a thermometer, a temperature-controlling unit and a condenser are charged 90.7 g of hexamethylene diisocyanate, 30.0 g of isophorone diisocyanate, 450 g of a polyester of sebacic acid and 3-methyl-1,5-pentanediol (Kurarepolyol P-3050, molecular weight 3000, produced by Kurare Co. Ltd.), and 450 g of a polyester of neopentyl glycol and adipic acid (Polylite OD-X-2044, molecular weight 2000, produced by Dainippon Ink). The content of the flask is heated to 80° C. and reacted for 5 hours. Successively, the reaction mixture is cooled to 60° C. Then, 194.9 g of an aliphatic epoxyacrylate (Ebecryl 112 produced by Daicel UCB Co., Ltd.), 0.6 g of methoquinone, and 0.3 g of dibutyltin dilaurate are charged thereto, followed by reacting at 80° C. for 7 hours. The disappearance of the remaining isocyanate group in the reaction mixture is confirmed by infrared absorption spectrum. Thereafter, 182.2 g of imide acrylate (Allonix TO-1429 produced by Toagosei Co., Ltd.) are charged to the reaction mixture, stirred for 2 hours and then taken out from the flask.

### Example 1

A 60 parts amount of the urethane acrylate obtained in Synthesis Example 1, 40 parts of imide acrylate (Allonix TO-1429 produced by Toagosei Co., Ltd.) as an acrylate-based reactive diluent, 4 parts of 2-hydroxy-2-methyl-1-phenylpropane-1-one as a photo-polymerization initiator and 1 part of a leveling agent (Florene AC300 produced by Kyoei Co., Ltd.) are mixed to prepare an ink. Printing is effected on a processed polypropylene sheet at a thickness of 20 μm according to screen printing. Thereafter, ultraviolet ray is irradiated thereto using three low-pressure mercury lamps (1 W/cm) from the 30 mm height at a line speed of 5 m/min. Thereafter, ultraviolet ray is irradiated thereto using a metal halide lamp (100 W/cm) from the 15 cm height at a line speed of 5 m/min.

Evaluation is effected according to the following evaluation method.

Odor: An ink is cured and allowed to stand for one day. Then the odor is determined by means of XP-329 manufactured by Cosmos Electric Co., Ltd.

Thermal yellowing resistance: An ink is allowed to stand in a thermostat bath at 110° C. for 500 hours. The difference of the color before the test from the color after the test, δE, is determined by means of a calorimeter.

Elongation rate: Maximum elongation (%) is determined according to the elongation determination method of JIS K-7127.

Matted state: Visually determined.

O; matted state is uniformly generated.

X; matted state is not generated

The evaluation results are shown in Table 1.

### Example 2

An ink is prepared according to the same manner as in Example 1 except that the photo-polymerization initiator is changed to oligo{2-hydroxy-2-methyl-1-phenylpropaneone} (IP150 produced by Lamberti Co., Ltd.). 2-stage irradiation of ultraviolet ray is effected thereto. The same evaluation as described above is effected.

The evaluation results are shown in Table 1.

### Example 3

An ink is prepared according to the same manner as in Example 2 except that the urethane acrylate obtained in Synthesis Example 1 is changed to the urethane acrylate obtained in Synthesis Example 2. 2-stage irradiation of ultraviolet ray is effected thereto. The same evaluation as described above is effected.

The evaluation results are shown in Table 1.

### Example 4

An ink is prepared according to the same manner as in Example 2 except that the urethane acrylate obtained in Synthesis Example 1 is changed to the urethane acrylate obtained in Synthesis Example 3. 2-stage irradiation of ultraviolet ray is effected thereto. The same evaluation as described above is effected.

The evaluation results are shown in Table 1.

### Comparative Example 1

An ink is prepared according to the same manner as in Example 1 except that the urethane acrylate obtained in Synthesis Example 1 is changed to 60 parts of commercially available urethane acrylate oligomer (UX-3204 produced by Nipponkayaku Co., Ltd.), 40 parts of HDDA (1,6-hexanedioldiacrylate), 4 parts of 1-hydroxycyclohexyl-phenyl-ketone, and 1 part of leveling agent (Florene AC300 produced by Kyoei Co., Ltd.). 2-stage irradiation of ultraviolet ray is effected thereto. The same evaluation as described above is effected.

The evaluation results are shown in Table 1.

### Comparative Example 2

An ink is prepared according to the same manner as in Example 1 except that the urethane acrylate oligomer is changed to another urethane acrylate oligomer (Actilane 170 produced by Acros Chemical Co., Ltd.). 2-stage irradiation of ultraviolet ray is effected thereto. The same evaluation as described above is effected.

The evaluation results are shown in Table 1.

### Comparative Example 3

An ink is prepared according to the same manner as in Example 1 except that IBXA (isobonyl acrylate) is used instead of HDDA in Comparative Example 1. 2-stage irradiation of ultraviolet ray is effected thereto. The same evaluation as described above is effected.

The evaluation results are shown in Table 1.

### Comparative Example 4

An ink is prepared according to the same manner as in Example 1 except that IBXA (isobonyl acrylate) is used instead of HDDA in Comparative Example 2. 2-stage irradiation of ultraviolet ray is effected thereto. The same evaluation as described above is effected.

The evaluation results are shown in Table 1.

TABLE 1

| | | Thermal | | |
|---|---|---|---|---|
| | | yellowing | | |
| | | resistance | Elongation | |
| Example No. | Matted state | (δE) | (%) | Odor |
| Example 1 | ◯ | 2.3 | 118 | 186 |
| Example 2 | ◯ | 2.3 | 118 | 12 |
| Example 3 | ◯ | 1.8 | 180 | 14 |
| Example 4 | ◯ | 1.8 | 190 | 14 |
| Comp. Ex. 1 | ◯ | 2.8 | 0 | 73 |
| Comp. Ex. 2 | ◯ | 3.0 | 0 | 84 |
| Comp. Ex. 3 | X | 3.5 | 35 | 243 |
| Comp. Ex. 4 | X | 4.5 | 50 | 273 |

As shown in the foregoing Examples, it can be seen that the ultraviolet ray curing type resin compositions of the present invention have a low degree of odor, a good elongation, thermal yellowing resistance and matted state. While, in Comparative Examples, it can be seen that even though the compositions have a good matted state, they have a small elongation rate and a poor thermal yellowing resistance.

### INDUSTRIAL APPLICABILITY

The ultraviolet ray curing type resin composition of the present invention can provide a cured coating film having a low degree of odor, a good elongation, thermal yellowing resistance and matted state, and further having excellent adhesion with a substrate, as described above. Thus, the composition can give a coated film suitable for a sheet for molding upon molding processing the sheet to form interior materials.

Because of being excellent in elongation of a coated film upon molding, even to a portion requiring a considerable elongation, the film has following capability to molding processing. The film does not cause cracks or breakages and also is not yellowed upon long term heating, i.e., has a desirable thermal resistance. Thus, it can be expected for the film to be used in a field wherein such molding following capability or thermal resistance is required. Further, the film can be used as a coating film for protecting plastics or as a coating material of an optical glass fiber. Still further, it can be used not only for forming a coating film, but also as resins for various kinds of molding.

1. An ultraviolet ray curing type resin composition comprising:
(A) an urethane acrylate including, as essential ingredients, (a) an isocyanate compound comprising an aliphatic isocyanate compound and an alicyclic isocyanate compound at a molar ratio of from 80/20 to 20/80, (b) a polyol compound comprising an ester-based polyol, an ether-based polyol or a polycarbonate-based polyol and (c) an acrylate compound having a hydroxyl group,
(B) an acrylate-based reactive diluent, and
(C) a photo-reactive initiator.

2. The ultraviolet ray curing type resin composition as claimed in claim 1, wherein
the molar ratio of the aliphatic isocyanate compound and the alicyclic isocyanate compound is from 80/20 to 50/50.

3. The ultraviolet ray curing type resin composition as claimed in claim 1, wherein
the acrylate-based reactive diluent is an acrylate-based reactive diluent having an imide group.

4. The ultraviolet ray curing type resin composition as claimed in claim 1, wherein
the photo-reactive initiator is a polymer of hydroxyketone.

5. The ultraviolet ray curing type resin composition as claimed in claim 1, wherein
the polyol compound is an ester-based polyol comprising sebacic acid and 3-methyl-1,5-pentanediol.

6. The ultraviolet ray curing type resin composition as claimed in claim 5, wherein
the ester-based polyol comprises an ester-based polyol comprising sebacic acid and 3-methyl-1,5-pentanediol and an ester-based polyol comprising adipic acid and neopentyl glycol, and
the ratio of the former to the latter is from 20/80 to 80/20.

7. The ultraviolet ray curing type resin composition as claimed in claim 1, wherein
the acrylate compound having a hydroxyl group is a monofunctional epoxyacrylate compound represented by the following general formula (1); 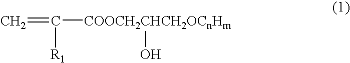
wherein R₁ represents H or CH₃; n is an integer of from 8 to 15; and m is an integer of from 17 to 31.

8. The ultraviolet ray curing type resin composition as claimed in claim 1, wherein
a molded product comprising the ultraviolet ray curing type resin composition has an elongation rate of 10% or more.

9. A method for forming a matted surface comprising:
a step of generating fine shrinks on the cured resin surface of the ultraviolet ray curing type resin composition as claimed in claim 1 by irradiating ultraviolet ray to the ultraviolet ray curing type resin composition using an ultraviolet lamp having maximum emission intensity at a wavelength of 300 nm or less and a 20% or less of relative emission intensity at a wavelength of from 300 nm to 800 nm; and
a step of curing of the composition to form the matted surface.

10. A method for forming a matted surface comprising:
a step of generating fine shrinks on the cured resin surface of the ultraviolet ray curing type resin composition as claimed in claim 1 by irradiating ultraviolet ray to the ultraviolet ray curing type resin composition using an ultraviolet lamp having maximum emission intensity at a wavelength of 300 nm or less and a 20% or less of relative emission intensity at a wavelength of from 300 nm to 800 nm to cause curing of the composition; and
a step of successively irradiating ultraviolet ray thereto using an ultraviolet lamp having maximum emission intensity at a wavelength of 300 nm or more to cause curing of the composition.
